(19) United States
(12) Patent Application Publication
(10) Pub. No.: US 2024/0127778 A1
(43) Pub. Date: Apr. 18, 2024

(54) WIRING STRUCTURE OF ELECTRONIC DRUM

(71) Applicant: Aroma Technology Ca., Limited, Huizhou (CN)

(72) Inventor: Haihua Chen, Huizhou (CN)

(21) Appl. No.: 18/544,604

(22) Filed: Dec. 19, 2023

(30) Foreign Application Priority Data
Nov. 20, 2023 (CN) 202323132297.0

(51) Int. Cl. G10H 1/32; G10D 13/10

(52) U.S. Cl. CPC G10H 1/32; G10D 13/26; G10H 2230/281

(57) ABSTRACT

The present disclosure discloses a wiring structure of an electronic drum, includes an electronic drum support assembly. The electronic drum support assembly includes a disposed first electronic drum support frame, a second electronic drum support frame disposed on a side of the first electronic drum support frame, a third electronic drum support frame disposed on an outer side of the first electronic drum support frame, a fourth electronic drum support frame disposed on an outer side of the second electronic drum support frame, a first transverse drum frame disposed at a top end of the third electronic drum support frame, a second transverse drum frame disposed at a top end of the fourth electronic drum support frame, a cymbal disposed at a position of the first transverse drum frame, and a snare drum disposed at a position of the second transverse drum frame; and a wiring assembly of an electronic drum.

### TECHNICAL FIELD

The present disclosure relates to the technical field of electronic drums, and in particular to a wiring structure of an electronic drum.

### BACKGROUND

An electronic drum slapstick itself is a receive sensor, namely, TRIGGER. At a moment that a drumstick hits a receiver of a drum slapstick, the TRIGGER senses a strength, transfers, through the conductor, the strength to a source drum machine, that is, MODULE, reads an output tone, and sends the output tone to a speaker. The speaker sounds, and the sound is heard by a person. The steps are a principle of the electronic drums.

In a conventional technology, when the electronic drum is placed, wires of the electronic drum are exposed and are external DB25 wires. As a result, connection wires are chaotic. This affects visual aesthetics. Therefore, a wiring structure of an electronic drum is provided.

### SUMMARY

Therefore, an objective of the present disclosure is to provide a wiring structure of an electronic drum. An electronic drum support structure is mutually cooperated with the wiring structure of the electronic drum. When a structural design of wiring in a drum is adopted during use, wires are connected to drums in iron tubes of the drum frame, and only a section of a plug is exposed. Therefore, the electronic drum has a neat appearance.

To solve the above technical problem, according to one aspect of the present disclosure, the present disclosure provides the following technical solution.

A wiring structure of an electronic drum includes:
an electronic drum support assembly, where the electronic drum support assembly includes a disposed first electronic drum support frame, a second electronic drum support frame disposed on a side of the first electronic drum support frame, a third electronic drum support frame disposed on an outer side of the first electronic drum support frame, a fourth electronic drum support frame disposed on an outer side of the second electronic drum support frame, a first transverse drum frame disposed at a top end of the third electronic drum support frame, a second transverse drum frame disposed at a top end of the fourth electronic drum support frame, a cymbal disposed at a position of the first transverse drum frame, and a snare drum disposed at a position of the second transverse drum frame; and
a wiring assembly of the electronic drum, where the wiring assembly of the electronic drum includes an elliptical opening provided in a side wall of the first electronic drum support frame, a conductor inserted into the elliptical opening, a silicone outgoing line sheet disposed on a side of the elliptical opening, an outgoing line port provided on a surface of the silicone outgoing line sheet, and an elliptical projection fastened to an inner side of the silicone outgoing line sheet.

As a preferred solution of the wiring structure of an electronic drum provided in the present disclosure, the first electronic drum support frame, the second electronic drum support frame, the third electronic drum support frame, the fourth electronic drum support frame, the first transverse drum frame, and the second transverse drum frame each are hollow structures, and corresponding elliptical openings each are provided on surfaces of each support frame and the drum frame.

As a preferred solution of the wiring structure of an electronic drum provided in the present disclosure, the elliptical projection is clamped with the elliptical opening, and the conductor penetrates through the silicone outgoing line sheet through the outgoing line port.

As a preferred solution of the wiring structure of an electronic drum provided in the present disclosure, the wiring structure of an electronic drum further includes a placement assembly. The placement assembly includes a cylindrical sleeve bound outer side of the fourth electronic drum support frame and a drumstick inserted into the cylindrical sleeve.

As a preferred solution of the wiring structure of an electronic drum provided in the present disclosure, the wiring structure of an electronic drum further includes a bottom drum. The bottom drum assembly includes a mounting support disposed directly below the snare drum, a pedal disposed on a side of the mounting support, and a spring disposed on a bottom surface of the pedal.

As a preferred solution of the wiring structure of an electronic drum provided in the present disclosure, the bottom drum assembly further includes a rotating shaft disposed between the mounting supports, an arc-shaped disk disposed on an outer side wall of the rotating shaft, a chain connected to the arc-shaped disk, a hammer connected to the surface of the arc-shaped disk, and a bottom drum disposed on a side of the hammer.

As a preferred solution of the wiring structure of an electronic drum provided in the present disclosure, the wiring structure of an electronic drum further includes a guiding assembly, where the guiding assembly includes a rectangular groove provided at a top end of the elliptical opening, a cylinder disposed inside the rectangular groove, a long cylinder connected to a side end of the cylinder, and a connection shaft shrunk inside the cylinder and the long cylinder.

As a preferred solution of the wiring structure of an electronic drum provided in the present disclosure, a diameter of the cylinder is larger than a diameter of the long cylinder, and the conductor is in contact with the long cylinder.

As a preferred solution of the wiring structure of an electronic drum provided in the present disclosure, the wiring structure of an electronic drum further includes a mounting assembly. The mounting assembly includes a concave frame fastened to two ends of the connection shaft, a threaded hole opened on a surface of the concave frame, and a threaded rod penetrating through the threaded hole.

As a preferred solution of the wiring structure of an electronic drum provided in the present disclosure, a tail end of the threaded rod is in mutual contact with an outer side wall of the first electronic drum support frame.

Compared with the prior art, the present disclosure has the following advantages:

The electronic drum support structure is mutually cooperated with the wiring structure of the electronic drum. When a structural design of wiring in a drum is adopted during use, wires are connected to the drums in iron tubes of the drum frame, and only a section of a plug is exposed. Therefore, the electronic drum has a neat appearance.

During use, a user sequentially threads the line through the outgoing line port and the elliptical opening, and moves the line in the hollow first electronic drum support frame. In addition, the first electronic drum support frame, the second electronic drum support frame, the third electronic drum support frame, the fourth electronic drum support frame, the first transverse drum frame, and the second transverse drum frame each are a hollow structure, and a corresponding elliptical openings is provided on a surface of each support frame and the drum frame. In this way, the wires can move in the support frames and the drum frames, to connect the drums. This avoids the wires from being chaotic. Therefore, an appearance is neat, and overall playing and viewing experience is ensured.

### BRIEF DESCRIPTION OF THE DRAWINGS

To describe the technical solutions in the implementations of the present disclosure more clearly, the present disclosure will be described in detail below in conjunction with the drawings and detailed implementations. Apparently, the drawings in the following description show merely some of the implementations of the present disclosure, and those of ordinary skill in the art may further derive other drawings from these drawings without creative efforts.

FIG. 1 is a front view of the present disclosure;

FIG. 2 is a lateral view of the present disclosure;

FIG. 3 is a schematic diagram of a structure of a first electronic dram support frame according to the present disclosure;

FIG. 4 is a schematic diagram of a structure of a silicone outgoing line sheet according to the present disclosure;

FIG. 5 is a schematic diagram of a structure of a guiding assembly according to the present disclosure; and

FIG. 6 is a schematic diagram of a structure of a mounting assembly according to the present disclosure.

Reference numerals: 11: first electronic drum support frame; 12: second electronic drum support frame; 13: third electronic drum support frame; 14: fourth electronic drum support frame; 15: first transverse drum frame; 16: second transverse drum frame; 17: cymbal; 18: snare drum; 21: elliptical opening; 22: conductor; 23: silicone outgoing line sheet; 24: outgoing line port; 25: elliptical projection; 31: mounting support; 32: pedal; 33: spring; 34: rotating shaft; 35: chain; 36: arc-shaped disk; 37: hammer; 38: bottom drum; 41: cylindrical sleeve; 42: drumstick; 51: rectangular groove; 52: cylinder; 53: long cylinder; 54: connection shaft; 61: concave frame; 62: threaded hole; 63 threaded rod.

### DETAILED DESCRIPTION OF THE EMBODIMENTS

To enable the objectives, features, and advantages mentioned above of the present disclosure to be more apparent and easily understood, specific implementations of the present disclosure will be described in detail below in conjunction with the drawings.

Many specific details are set forth in the following description to facilitate full understanding of the present disclosure, but the present disclosure may also be implemented in other ways different from those described herein, similar derivatives may be made by those skilled in the without departing from the connotation of the present disclosure, and therefore, the present disclosure is not limited by the specific implementations disclosed below.

Thirdly, the present disclosure is described in detail in combination with the schematic diagrams. When the implementations of the present disclosure are described in detail, for the convenience of description, the sectional views of the structure of the device will not be locally enlarged according to a general scale, and the schematic diagrams are merely examples, and may not limit the protection scope of the present disclosure. In addition, the three-dimensional space dimensions of length, width and depth should be included in the actual production.

In order to make the objective, technical solution and advantages of the present disclosure clearer, implementations of the present disclosure will be further described in detail in combination with the accompanying drawings.

According to the wiring structure of an electronic drum, the electronic drum support structure is mutually cooperated with the wiring structure of the electronic drum. When a structural design of wiring in a drum is adopted during use, wires are connected to drums in iron tubes of the drum frame, and only a section of a plug is exposed. Therefore, the electronic drum has a neat appearance.

### Embodiment 1

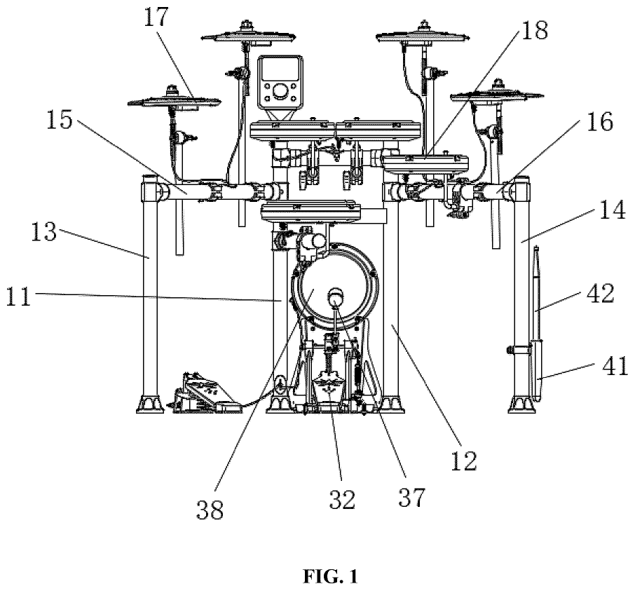

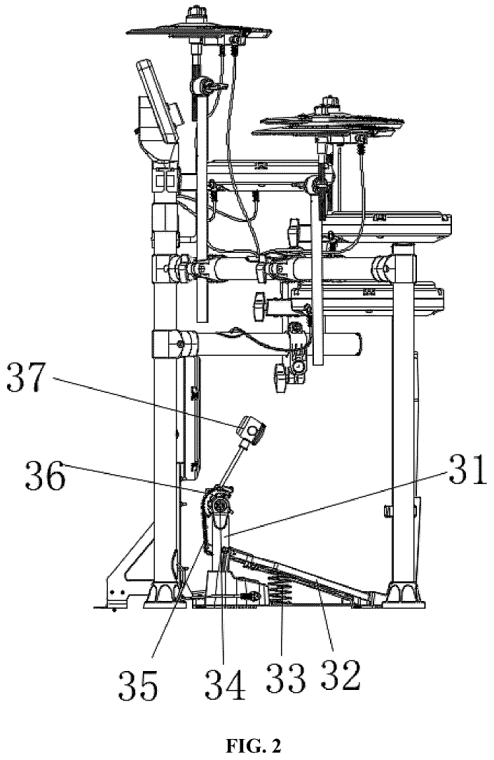

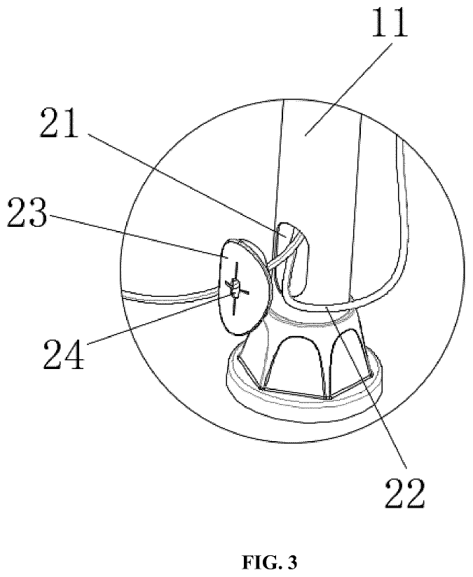

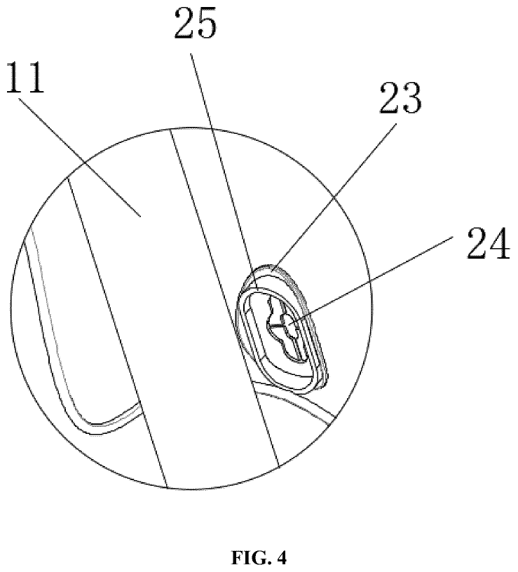

FIG. 1, FIG. 2, FIG. 3, and FIG. 4 show schematic diagrams of an overall structure of an implementation of a wiring structure of an electronic drum according to the present disclosure. As shown in FIG. 1, FIG. 2, FIG. 3, and FIG. 4. A main structure in this implementation includes: an electronic drum support assembly, a wiring assembly of the electronic drum.

The electronic drum support assembly is used to support each drum. Specifically, the electronic drum support assembly includes a disposed first electronic drum support frame 11, a second electronic drum support frame 12 disposed on a side of the first electronic drum support frame 11, a third electronic drum support frame 13 disposed on an outer side of the first electronic drum support frame 11, a fourth electronic drum support frame 14 disposed on an outer side of the second electronic drum support frame 12, a first transverse drum frame 15 disposed at a top end of the third electronic drum support frame 13, a second transverse drum frame 16 disposed at a top end of the fourth electronic drum support frame 14, a cymbal 17 disposed at a position of the first transverse drum frame 15, and a snare drum 18 disposed at a position of the second transverse drum frame 16. During specific use, the wiring assembly of the electronic drum is disposed and used based on the first electronic drum support frame 11, the second electronic drum support frame 12 the third electronic drum support frame 13 the fourth electronic drum support frame 14, the first transverse drum frame 15, and the second transverse drum frame 16, and the drums are supported by the support frames.

The wiring assembly of the electronic drum is used to form an internal wiring structure. Specifically, the wiring assembly of the electronic drum includes an elliptical opening 21 provided in a side wall of the first electronic drum support frame 11, a conductor 22 inserted into the elliptical opening 21, a silicone outgoing line sheet 23 disposed on a side of the elliptical opening 21, an outgoing line port 24 provided on a surface of the silicone outgoing line sheet 23, and an elliptical projection 25 fastened to an inner side of the silicone outgoing line sheet 23. During specific use, a user sequentially threads the line through the outgoing line port 24 and the elliptical opening 21, and moves the line in the hollow first electronic drum support frame 11. In addition, because the first electronic drum support frame 11, the second electronic drum support frame 12, the third electronic drum support frame 13, the fourth electronic drum support frame 14, the first transverse drum frame 15, and the second transverse drum frame 16 each are a hollow structure, and a corresponding elliptical openings 21 is provided on a surface of each support frame and the drum frame. In this way, the wires can move in the support frames and the drum frames, to connect the drums. This avoids the wires from being chaotic. Therefore, an appearance is neat, and overall playing and viewing experience is ensured.

The wiring structure of an electronic drum further includes a bottom drum assembly. The bottom drum assembly includes a mounting support 31 directly disposed below the snare drum 18, a pedal 32 disposed on a side of the mounting support 31, and a spring 33 disposed on a bottom surface of the pedal 32. The bottom drum assembly further includes a rotating shaft 34 disposed between the mounting support 31, an arc-shaped disk 36 disposed on an outer side wall of the rotating shaft 34, a chain 35 connected to the arc-shaped disk 36, a hammer 37 connected to the surface of the arc-shaped disk 36, and a bottom drum 38 disposed on a side of the hammer 37. During specific use, the user steps on the pedal 32. In this case, the pedal 32 drives the chain 35 to move, and the chain 35 drives the arc-shaped disk 36 to move. In this way, the arc-shaped disk 36 drives the rotating shaft 34 to rotate, to enable the hammer 37 to hit the bottom drum 38. During hitting, the pedal 32 compresses the spring 33. After hitting, the pedal is released, and the spring 33 telescopes to drive the pedal 32 to reset.

The wiring structure of an electronic drum further includes a placement assembly. The placement assembly includes a cylindrical sleeve 41 bound to an outer side of the fourth electronic drum support frame 14 and a drumstick 42 inserted into the cylindrical sleeve 41. During specific use, after using the drumstick 42, the user places the drumstick 42 inside the cylindrical sleeve 41.

### Embodiment 2

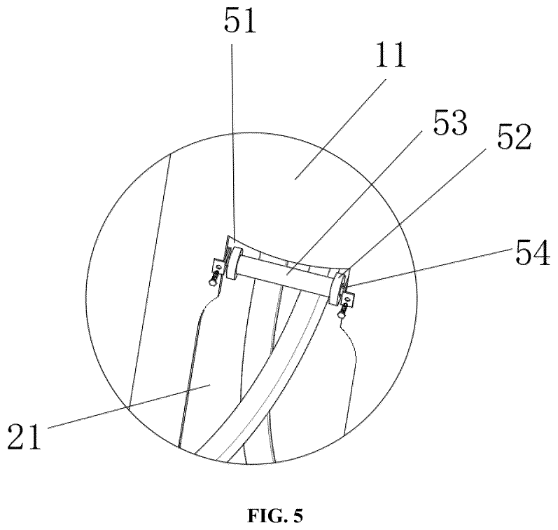

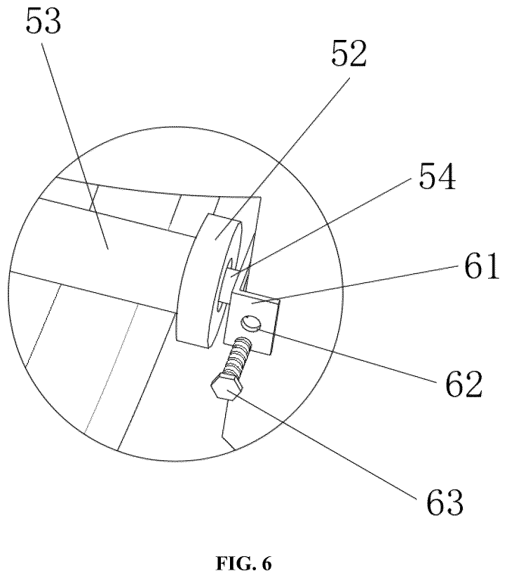

As shown in FIG. 5 and FIG. 6, the wiring structure of an electronic drum further includes a guiding assembly. The guiding assembly includes a rectangular groove 51 provided at a top end of the elliptical opening 21, a cylinder 52 disposed inside the rectangular groove 51, a long cylinder 53 connected to a side end of the cylinder 52, and a connection shaft 54 shrunk inside the cylinder 52 and the long cylinder 53. During specific use, the conductor 22 is in contact with the long cylinder 53. In this way, when the conductor 22 is moved, the conductor 22 drives the long cylinder 53 to rotate on a surface of the connection shaft 54. This structural design resolves a problem that the conductor 22 is damaged because of a large friction between the conductor 22 and an edge of the elliptical opening 21 when a position of the conductor 22 is adjusted.

A diameter of the cylinder 52 is larger than a diameter of the long cylinder 53, and the conductor 22 is in contact with the long cylinder 53. In this way, the cylinder 52 and the long cylinder 53 forms a groove, and the conductor 22 moves on a surface of the long cylinder 53, to prevent disengagement.

The wiring structure of an electronic drum further includes a mounting assembly. The mounting assembly includes a concave frame 61 fastened to two ends of the connection shaft 54, a threaded hole 62 opened on a surface of the concave frame 61, and a threaded rod 63 penetrating through the threaded hole 62. During specific use, the user vertically moves the concave frame 61. When the concave frame 61 moves to a desired position, the user rotates the threaded rod 63, and push forward the threaded rod 63 in the threaded hole 62 through an internal thread, to directly limit the concave frame 61. Due to this structural design, the entire guiding assembly can be locked in any desired position. This improves applicability.

The tail end of the threaded rod 63 abuts against an outer side wall of the first electronic drum support frame 11, so that the concave frame 61 can be locked, and displacement can be avoided.

Although the present disclosure has been described above with reference to the implementations, various improvements can be made and components therein can be replaced with equivalents without departing from the scope of the present disclosure. In particular, as long as there is no structural conflict, various features in the implementations disclosed in the present disclosure can be combined with each other in any manner. These combinations are not exhaustively described in this specification only for the sake of omitting space and saving resources. The present disclosure is not limited to the specific implementations disclosed herein, but shall include all technical solutions falling within the scope of the claims.

1. A wiring structure of an electronic drum, comprising:
an electronic drum support assembly, wherein the electronic drum support assembly comprises a disposed first electronic drum support frame (11), a second electronic drum support frame (12) disposed on a side of the first electronic drum support frame (11), a third electronic drum support frame (13) disposed on an outer side of the first electronic drum support frame (11), a fourth electronic drum support frame (14) disposed on an outer side of the second electronic drum support frame (12), a first transverse drum frame (15) disposed at a top end of the third electronic drum support frame (13), a second transverse drum frame (16) disposed at a top end of the fourth electronic drum support frame (14), a cymbal (17) disposed at a position of the first transverse drum frame (15), and a snare drum (18) disposed at a position of the second transverse drum frame (16); and
a wiring assembly of the electronic drum, wherein the wiring assembly of the electronic drum comprises an elliptical opening (21) provided in a side wall of the first electronic drum support frame (11), a conductor (22) inserted into the elliptical opening (21), a silicone outgoing line sheet (23) disposed on a side of the elliptical opening (21), an outgoing line port (24) provided on a surface of the silicone outgoing line sheet (23), and an elliptical projection (25) fastened to an inner side of the silicone outgoing line sheet (23).

2. The wiring structure of an electronic drum according to claim 1, wherein the first electronic drum support frame (11), the second electronic drum support frame (12), the third electronic drum support frame (13), the fourth electronic drum support frame (14), the first transverse drum frame (15), and the second transverse drum frame (16) each are hollow structures, and corresponding elliptical openings (21) each are provided on surfaces of each support frame and the drum frame.

3. The wiring structure of an electronic drum according to claim 2, wherein the elliptical projection (25) is clamped with the elliptical opening (21), and the conductor (22) penetrates through the silicone outgoing line sheet (23) through the outgoing line port (24).

4. The wiring structure of an electronic drum according to claim 3, further comprising a placement assembly, the placement assembly comprises a cylindrical sleeve (41) bound to an outer side of the fourth electronic drum support frame (14) and a drumstick (42) inserted into the cylindrical sleeve (41).

5. The wiring structure of an electronic drum according to claim 4, further comprising a bottom drum assembly, wherein the bottom drum assembly comprises a mounting support (31) disposed directly below the snare drum (18), a pedal (32) disposed on a side of the mounting support (31), and a spring (33) disposed on a bottom surface of the pedal (32).

6. The wiring structure of an electronic drum according to claim 5, wherein the bottom drum assembly further comprises a rotating shaft (34) disposed between the mounting supports (31), an arc-shaped disk (36) disposed on an outer side wall of the rotating shaft (34), a chain (35) connected to the arc-shaped disk (36), a hammer (37) connected to the surface of the arc-shaped disk (36), and a bottom drum (38) disposed on a side of the hammer (37).

7. The wiring structure of an electronic drum according to claim 6, further comprising a guiding assembly, wherein the guiding assembly comprises a rectangular groove (51) provided at a top end of the elliptical opening (21), a cylinder (52) disposed inside the rectangular groove (51), a long cylinder (53) connected to a side end of the cylinder (52), and a connection shaft (54) shrunk inside the cylinder (52) and the long cylinder (53).

8. The wiring structure of an electronic drum according to claim 7, wherein a diameter of the cylinder (52) is larger than a diameter of the long cylinder (53), and the conductor (22) is in contact with the long cylinder (53).

9. The wiring structure of an electronic drum according to claim 8, further comprising a mounting assembly, wherein the mounting assembly comprises a concave frame (61) fastened to two ends of the connection shaft (54), a threaded hole (62) opened on a surface of the concave frame (61), and a threaded rod (63) penetrating through the threaded hole (62).

10. The wiring structure of an electronic drum according to claim 9, wherein a tail end of the threaded rod (63) is in mutual contact with an outer side wall of the first electronic drum support frame (11).
